(19) United States
(12) Patent Application Publication
(10) Pub. No.: US 2022/0391832 A1
(43) Pub. Date: Dec. 8, 2022

(54) ORDER DELIVERY TIME PREDICTION

(71) Applicant: Dell Products L.P., Round Rock, TX (US)

(72) Inventors: Bijan Mohanty, Austin, TX (US); Hung Dinh, Austin, TX (US); Satyam Sheshansh, Bangalore (IN); Durga Ram Singh Bondili, Chennai (IN)

(73) Assignee: Dell Products L.P., Round Rock, TX (US)

(21) Appl. No.: 17/383,866

(22) Filed: Jul. 23, 2021

(30) Foreign Application Priority Data
Jun. 4, 2021 (IN) 202141024988

(51) Int. Cl. G06Q 10/08; G06N 3/04

(52) U.S. Cl. CPC G06Q 10/0833; G06N 3/04

(57) ABSTRACT

In one aspect, an example methodology implementing the disclosed techniques includes receiving a corpus of historical order fulfillment data regarding a plurality of completed orders for one or more products, the historical order fulfillment data including an actual delivery time for each product in a completed order, and identifying, from the corpus of historical order fulfillment data, a plurality of features for a product, the plurality of features correlated with an actual delivery time for the product. The method also includes generating a training dataset using the identified plurality of features, the training dataset including a plurality of training samples, each training sample of the plurality of training samples corresponding to a product and including one or more identified features and the actual delivery time for the product. The method may include training the delivery time prediction module using the plurality of training samples.

### CROSS REFERENCE TO RELATED APPLICATION

This application claims the benefit of India Patent Application No. 202141024988 filed on Jun. 4, 2021 in the English Language in the India Intellectual Property Office, the contents of which are hereby incorporated herein by reference in its entirety.

### BACKGROUND

Along with cost, an important factor in the sales process and the resulting purchase decision is often an expected delivery time of an order for a product. Both the customer of a product and the seller of the product, who may be the manufacturer, benefit from using accurate expected delivery times. For example, the customer often requires the product to be delivered by a specified delivery time and failure to deliver the product by the specified time (e.g., date) may negatively impact customer satisfaction. The manufacturer depends on accurate predictions of delivery times in order to maintain its reputation and increase revenue.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a computer implemented method to generate a delivery time prediction module to predict an expected delivery time for a product includes receiving a corpus of historical order fulfillment data regarding a plurality of completed orders for one or more products, the historical order fulfillment data including an actual delivery time for each product in a completed order, and identifying, from the corpus of historical order fulfillment data, a plurality of features for a product, the plurality of features correlated with an actual delivery time for the product. The method also includes generating a training dataset using the identified plurality of features, the training dataset including a plurality of training samples, each training sample of the plurality of training samples corresponding to a product and including one or more identified features and the actual delivery time for the product. The method may further include training the delivery time prediction module using the plurality of training samples.

In some embodiments, the plurality of features includes a feature regarding a customer location that indicates a location at which a customer received the product.

In some embodiments, the plurality of features includes a feature regarding a manufacturing location that indicates a location at which the product is manufactured.

In some embodiments, the plurality of features of includes a feature regarding a supplier location that indicates a location of a supplier of a component of the product.

In some embodiments, the plurality of features includes a feature regarding a logistics provider that indicates a company that provided delivery of the product.

In some embodiments, the plurality of features includes a feature that indicates a quantity of the product.

In some embodiments, the plurality of features includes a feature indicating a time period associated with the order of the product.

In some embodiments, the delivery time prediction module includes a regression-based model.

In some embodiments, the regression-based model includes an input layer that includes a number of neurons that match the plurality of features included in a training sample of the plurality of training samples.

In some embodiments, the regression-based model includes a plurality of hidden layers, each hidden layer of the plurality of hidden layers including a number of neurons based on a number of neurons included in an input layer of the regression-based model.

In some embodiments, the method further includes receiving an order for at least one product, generating a feature vector for the at least one product, and predicting, by the delivery time prediction module, an expected delivery time for the at least one product based on the generated feature vector.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to receive a corpus of historical order fulfillment data regarding a plurality of completed orders for one or more products, the historical order fulfillment data including an actual delivery time for each product in a completed order, and identify, from the corpus of historical order fulfillment data, a plurality of features for a product, the plurality of features correlated with an actual delivery time for the product. Execution of the instructions also causes the one or more processors to generate a training dataset using the identified plurality of features, the training dataset including a plurality of training samples, each training sample of the plurality of training samples corresponding to a product and including one or more identified features and the actual delivery time for the product. Execution of the instructions may further cause the one or more processors to train the delivery time prediction module using the plurality of training samples.

In some embodiments, the plurality of features includes a feature regarding one of a customer location that indicates a location at which a customer received the product, a manufacturing location that indicates a location at which the product is manufactured, or a supplier location that indicates a location of a supplier of a component of the product.

In some embodiments, the plurality of features includes a feature regarding a logistics provider that indicates a company that provided delivery of the product.

In some embodiments, the plurality of features includes a feature that indicates a quantity of the product.

In some embodiments, the plurality of features includes a feature indicating a time period associated with the order of the product.

In some embodiments, the delivery time prediction module includes a regression-based model.

In some embodiments, the regression-based model includes an input layer that includes a number of neurons that match the plurality of features included in a training sample of the plurality of training samples.

In some embodiments, the regression-based model includes a plurality of hidden layers, each hidden layer of the plurality of hidden layers including a number of neurons based on a number of neurons included in an input layer of the regression-based model.

In some embodiments, execution of the instructions further causes the one or more processors to receive an order for at least one product, generate a feature vector for the at least one product, and predict an expected delivery time for the at least one product based on the generated feature vector.

According to another illustrative embodiment provided to illustrate the broader concepts described herein, a computer program product includes one or more non-transitory machine-readable mediums encoding instructions that when executed by one or more processors cause a process to be carried out to generate a delivery time prediction module to predict an expected delivery time for a product. The process includes receiving a corpus of historical order fulfillment data regarding a plurality of completed orders for one or more products, the historical order fulfillment data including an actual delivery time for each product in a completed order, and identifying, from the corpus of historical order fulfillment data, a plurality of features for a product, the plurality of features correlated with an actual delivery time for the product. The process also includes generating a training dataset using the identified plurality of features, the training dataset including a plurality of training samples, each training sample of the plurality of training samples corresponding to a product and including one or more identified features and the actual delivery time for the product. The process may further include training the delivery time prediction module using the plurality of training samples.

In some embodiments, the process further includes receiving an order for at least one product, generating a feature vector for the at least one product, and predicting, by the delivery time prediction module, an expected delivery time for the at least one product based on the generated feature vector.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an illustrative workflow for training a model, in accordance with an embodiment of the present disclosure.

FIG. 2 is a diagram of an illustrative system architecture including a delivery time prediction system, in accordance with an embodiment of the present disclosure.

FIG. 3 is a diagram showing an illustrative data structure that represents a training dataset, in accordance with an embodiment of the present disclosure.

FIG. 4 is a diagram illustrating an example architecture of a dense artificial neural network (ANN) model of a delivery time prediction module, in accordance with an embodiment of the present disclosure.

FIG. 5 schematically shows selective components of an illustrative computer system that may be used in accordance with an embodiment of the concepts, structures, and techniques disclosed herein.

### DETAILED DESCRIPTION

Existing techniques for determining expected delivery times often rely on static and heuristic-based rules to estimate an expected delivery time of an order. Typically, these static and heuristic-based rules calculate the expected delivery time as the sum of the manufacturing and transportation lead times. For a product, the manufacturing lead time may include the actual in-house manufacturing process lead time and the procurement lead time to procure the individual components needed to manufacture (or make) the product from the suppliers. These lead times are typically based on commitments from the manufacturing team and the component suppliers based on an understanding of their capacities and constraints, as well as the agreed-upon service level agreements (SLAs). Unfortunately, these SLAs often include sufficient leeway with respect to the promised delivery times and dates. Thus, existing techniques that rely on static and heuristic-based rules that utilize static and inaccurate lead times often generate inaccurate estimates of expected delivery times. Furthermore, it is recognized herein that omission of various dynamic factors regarding or otherwise related to manufacturing, procurement, and/or transportation lead times in determining an expected delivery time of an order may also cause the actual delivery time to vary and, in some cases, significantly vary from the expected (or promised) order delivery time.

It is appreciated herein that historical order fulfillment data is a very good indicator for accurately estimating an expected delivery time for a future order. Thus, embodiments of the concepts, techniques, and structures disclosed herein are directed to determination of expected delivery times for orders that are based on historical order fulfillment data. For example, an order may be for one or more products, where some of the products may be complex products that include many parts (or components) and various suppliers of these parts. In certain embodiments, the disclosed techniques leverage supervised learning to train a learning model (e.g., a regression-based deep learning model) using machine learning techniques (including neural networks) with historical order fulfillment data regarding completed orders for one or more products. The historical order fulfillment data can include a fulfillment time (e.g., an actual delivery time) of each product contained in a completed order. To this end, historical order fulfillment data (i.e., data regarding the completed orders) is collected. Once the historical order data is collected, the variables or parameters (also called features) that are correlated to or influence (or contribute to) the fulfillment time recorded for a product are filtered, identified, and/or extracted. These important features are then used to generate a dataset (e.g., a training dataset) that can be used to train the model. A feature (also known as an independent variable in machine learning) is an attribute that is useful or meaningful to the problem that is being modeled (i.e., predicting an expected delivery time for a product). Nonlimiting examples of such important features include information regarding dates of the orders and the fulfillment of the orders, products, parts, customer, location of delivery, location of manufacturing, material suppliers, and logistic providers.

During the training of the model, the important features are input (fed) into the model as the independent variables and the fulfillment time of the products in the dataset as the dependent (or target) variable. Thus, the model is trained to factor a multitude of dynamic factors (i.e., the important features) as learned from the historical order fulfillment data and provide predictions of expected delivery times that are more accurate as compared to the estimated expected delivery times generated using the aforementioned static and heuristic-based rules. Then, upon receiving an order for one or more products, or an inquiry as to an expected delivery time for an order for one or more products, the trained model can be used to predict an expected delivery time for the one or more products included in the order.

In some embodiments, a multi-phase approach may be utilized to train a model to predict an expected delivery time for a provided product. An estimate of an expected delivery time for an order for one or more products can then be determined or otherwise calculated from (or based on) the predicted expected delivery times for the individual products output or otherwise generated from the trained model. For example, suppose that an order is for one workstation and two monitors, and the trained model predicts an expected delivery time of four days for the workstation and an expected delivery time of five days for the two monitors. Based on these predicted expected delivery times, an expected delivery time of five days can be determined for the order for the one workstation and two monitors.

In accordance with an embodiment of the present disclosure, the multi-phase approach includes a data collection phase, a feature filtering phase, a feature engineering phase, and a model training phase. As will be appreciated, these phases are used for purposes facilitating discussion and should not be construed as structural or otherwise rigid limitations. For instance, the feature filtering phase and the feature engineering phase may be combined into a single phase between the data collection and model training phases, wherein that single phase generates the training dataset that is used in the model training phase. Also, the feature engineering phase may include multiple sub-phases to identify the features that have influence on the performance of the model (i.e., that are relevant (or influential) in predicting an expected delivery time). In short, any number of phases can be used to provide the various functionality provided herein. Numerous embodiments will be apparent.

In the data collection phase, a corpus of historical order fulfillment data may be obtained from which to generate the labeled training data. The corpus of historical order fulfillment data may include order fulfillment information such as, for example, information regarding the products, their parts (or components), suppliers, actual time taken during each step (stage) in the product manufacturing process, and the actual product delivery time. For example, an enterprise, such as a product manufacturing and sales organization, may obtain the historical order information from the data (e.g., records) stored or otherwise maintained in their enterprise resource planning (ERP) systems, order management systems (OMSs), supply chain management (SCM) systems, and other databases and systems used to maintain historical product sales records.

In the feature filtering phase, the historical order information collected in the data collection phase may be filtered to select those features that may have some correlation to the dependent variable (i.e., the actual delivery time for a product recorded in the historical order fulfillment data). For example, in addition to the aforementioned information regarding the products, their parts, suppliers, and actual time taken during each step in the product manufacturing process, and the actual product delivery time, the collected historical order information may also include extraneous information, such as governance information, compliance information, and other information that is not correlated to the product delivery time. Such extraneous information is irrelevant to the problem (i.e., predicting an expected delivery time) and may be removed or eliminated from the collected information and not included in the features used to generate the training data. In other words, the extraneous information is excluded and not selected as relevant features for use in model construction.

In the feature engineering phase, the features that are more important or highly correlated with the dependent variable (i.e., the actual delivery time for a product) may be identified. In some embodiments, predictive modeling algorithms suitable for performing feature importance and selections, such as a random forest, may be trained and used to determine the features that are the important (more relevant) features. In some cases, feature extraction may also be performed to construct new features from the historical order information. In any case, the determined relevant features (i.e., the features determined to be more relevant to the problem of predicting an expected delivery time) may be used to generate the training dataset.

In the model training phase, a model may be trained using machine learning algorithms based on the training dataset including any, some, or all of the features from the feature engineering phase. In various embodiments, various different types of trained models may be used, including a deep learning model (e.g., a regression-based deep learning model) or any other machine learning or artificial intelligence-based prediction system that may execute supervised or unsupervised learning techniques. For the machine learning model or model type, one or more appropriate data structures may be generated, and the model may be trained using the corresponding machine learning algorithms based on the training dataset. Once trained, the trained model can be used to predict an expected delivery time for a product. The predictions generated by the trained models can then be used to determine an expected delivery time for an order for one or more products.

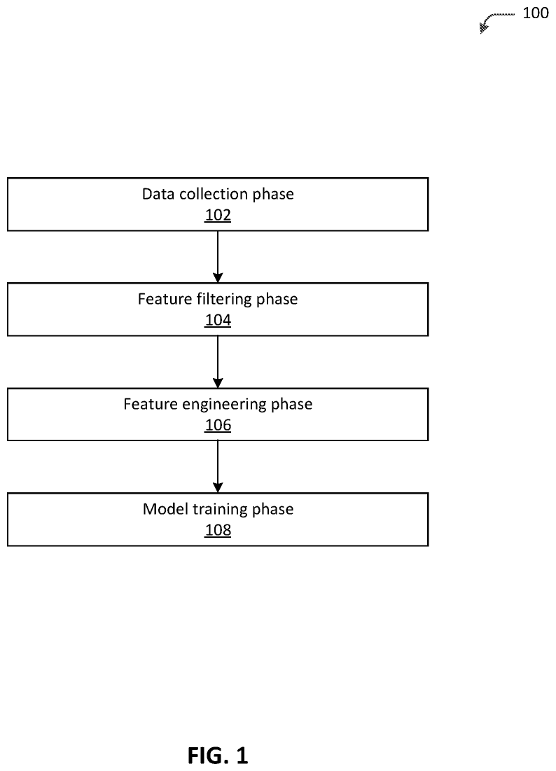

Referring now to the figures, FIG. 1 is a diagram of an illustrative workflow 100 for training a model, in accordance with an embodiment of the present disclosure. As depicted, workflow 100 includes a data collection phase 102, a feature filtering phase 104, a feature engineering phase 106, and a model training phase 108. In more detail, data collection phase 102 includes collecting a corpus of historical order fulfillment data from which to generate the labeled training data (e.g., dataset or datasets of training samples) for training one or more models to predict expected delivery times for products. The corpus of historical order fulfillment data, which may include order fulfillment information such as, for example, information regarding the products, the parts included in or otherwise used to manufacture the products, suppliers, actual times taken during each step (stage) in the product manufacturing process, and the actual product delivery time, may be readily obtained by an enterprise. For example, an enterprise, such as a product manufacturing and sales organization, may obtain the historical order fulfillment information from the data (e.g., records) stored or otherwise maintained in the ERP systems, the OMSs, the SCM systems, and/or other databases and systems used by the enterprise to maintain historical product sales records. In some cases, the records containing the historical order fulfillment data may be in tabular form (e.g., one or more data structures, e.g., tables, containing the records). In any case, information regarding a large number and, in some cases, a very large number of historical product (asset) sales (i.e., observations of historical product/asset sales) and data regarding the hundreds, thousands and, in some cases, millions of variables associated with these historical product sales may be collected from which to generate the labeled training data.

Feature filtering phase 104 includes filtering the collected information (e.g., collected corpus of historical order fulfillment data) to select those features which may contribute to the dependent variable (i.e., the actual product delivery time recorded in the historical order fulfillment data). Here, the premise is that the collected corpus of data contains some features that are either redundant or irrelevant and can thus be not considered (removed) without incurring much loss of information. For example, in addition to the data regarding product manufacturing and transportation lead times (e.g., information regarding the products, their parts, suppliers, and actual time taken during each step in the product manufacturing process, and the actual product delivery time), the collected information may also include extraneous information, such as governance information, compliance information, payroll information, and other information that is not correlated to the product delivery time. Such extraneous information is irrelevant to the problem (i.e., predicting an expected delivery time) and may be excluded from the collected information and not included in the features used to generate the training data. As an example, historical order data may include an order number (e.g., a unique identifier given to an order), which has no influence on the actual delivery time of an order and which should be excluded.

Feature engineering phase 106 includes identifying, from the features selected during feature filtering phase 104, the features that are more important or highly correlated with the dependent variable. The identified features are the features that better represent the underlying problem to the predictive model (i.e., predicting an expected delivery time for a product), which results in improved model accuracy on unseen data. In some embodiments, predictive modeling algorithms suitable for performing feature importance and selections, such as a random forest, may be trained and used to determine the features that are the important (more relevant) features. In some cases, feature extraction may also be performed to construct new features from the historical order information. In any case, the determined relevant features (i.e., the features determined to be more relevant to the problem of predicting an expected delivery time) may be used to generate the training dataset.

It is appreciated that machine learning algorithms use input data to create the outputs (the predictions). The input data comprise features (e.g., the important or highly correlated features) that may be in the form of structured columns. It is also appreciated that in these machine learning algorithms, every instance may be represented by a row in the training dataset, where a column shows a different feature of the instance. In such cases, feature engineering phase 106 may include various kinds of pre-processing, such as imputation, handling outliers, binning, one-hot encoding, scaling, date extraction, and other feature extraction techniques to properly prepare the input dataset (i.e., training dataset) to improve the performance of the machine learning model. For example, although date columns may provide useful information regarding the model target variable, the dates can be represented in numerous formats, which make it hard to understand by a machine learning algorithm. To make a date understandable to the machine learning algorithm, the parts of the date (e.g., year, month, day, etc.) can be extracted into different columns. As another example, null or missing values in a column (a feature) may be replaced by a median value of the values in that column. As another example, since machine learning deals with numerical values, textual categorical values in the columns (e.g., model numbers, part numbers, addresses, e.g., street, city, state, country, etc., names, etc.) are converted (i.e., encoded) into numerical values.

As an example of relevant features, in the case of a product being a computing device, such as a personal computer or a laptop computer, the relevant features may include a customer that is purchasing the computing device, a model or product number of the computing device, a quantity of the computing devices that is being purchased, one or more specific parts (or components) needed to manufacture or otherwise make the computing device, a supplier or suppliers of the one or more parts, a location or locations from which the one or more parts are being supplied from, a location at which the computing device is being manufactured, a location at which the customer is receiving delivery of the computing device, a date on which the order for the computing device is placed, a logistics provider being used to deliver the computing device to the customer, and other features that may be highly correlated with the dependent variable (i.e., the actual delivery time for the ordered computing device(s)). In this example case of a computing device, the specific parts that may be included as relevant features may include parts purchased or otherwise obtained from vendors, such as, for example, a storage device (e.g., a solid state drive (SSD) or a hard disk drive (HDD)), a motherboard, a processor, a video card, memory (e.g., random access memory (RAM)), power supply, monitor, keyboard, and mouse. Note that some or all of the parts may be manufactured by the manufacturer of the computing device and not obtained from vendors.

As another example of relevant features, in the case of a product being an electronics device, such as a television (TV), the relevant features may include a customer that is purchasing the TV, a model or product number of the TV, a quantity of the TVs that is being purchased, one or more specific parts (or components) needed to manufacture or otherwise make the TV, a supplier or suppliers of the one or more parts, a location or locations from which the one or more parts are being supplied from, a location at which the TV is being manufactured, a location at which the customer is receiving delivery of the TV, a date on which the order for the TV is placed, a logistics provider being used to deliver the TV to the customer, and other features that may be highly correlated with the dependent variable (i.e., the actual delivery time for the ordered TV(s)). In this example case of a TV, the specific parts that may be included as relevant features may include parts purchased or otherwise obtained from vendors, such as, for example, a display screen (e.g., a liquid crystal display (LCD) panel, light-emitting diode (LED) panel, or an organic LED (OLED) panel), a backlight, a tuner, a reflective panel, input/output module(s) (e.g., speakers, Bluetooth® module, WiFi module, etc.), operation touch button, main board, power board, tuner, cover (e.g., middle cover, rear cover, etc.), and remote control device. Note that some or all of the parts may be manufactured by the manufacturer of the electronics device and not obtained from vendors.

As still another example of relevant feature, in the case of a product being a custom, build-to-order motor vehicle, such as an automobile, the relevant features may include a customer that is purchasing the automobile, a model of the automobile, a quantity of the automobiles that is being purchased, one or more specific parts (or components) needed to manufacture or otherwise make the automobile, a supplier or suppliers of the one or more parts, a location or locations from which the one or more parts are being supplied from, a location at which the automobile is being manufactured, a location at which the customer is receiving delivery of the automobile, a date on which the order for the automobile is placed, a logistics provider being used to deliver the automobile to the customer, and other features that may be highly correlated with the dependent variable (i.e., the actual delivery time for the ordered automobile(s)). In this example case of an automobile, the specific parts that may be included as relevant features may include parts purchased or otherwise obtained from vendors, such as, for example, an engine, a transmission system, a chassis, a body, a battery, front axle assembly, rear axle assembly, front steering and suspension assembly, brakes, tires, rear suspension assembly, windshield, and interior assembly. Note that some or all of the parts may be manufactured by the manufacturer of the motor vehicle and not obtained from vendors.

Model training phase 108 includes training a model (e.g., a regression-based deep learning model) using some or all of the relevant features identified during feature engineering phase 106. For example, each training sample may correspond to a product (e.g., a product included in a historical completed order) and include one or more of the identified relevant features as independent variables, and the recorded fulfillment time (e.g., actual delivery time) of a product as the dependent (or target) variable. Typically, model training phase 108 may utilize a training dataset and validation dataset comprising a set of training and validation examples. The validation dataset may be a separate portion of the same dataset (e.g., the relevant features identified during feature engineering phase 106) from which the training dataset is derived. For example, full batch learning, mini-batch learning, stochastic gradient descent, or any other training methods may be employed. Upon training of the model using the training dataset, the trained model can be evaluated (i.e., validated) using the validation dataset. The validation dataset may be a separate portion of the same dataset (e.g., the relevant features identified during feature engineering phase 106) from which the training dataset is derived.

Once trained using the training dataset, the trained model can be used to predict, provided a product that is being ordered or being inquired about, an expected delivery time for the product.

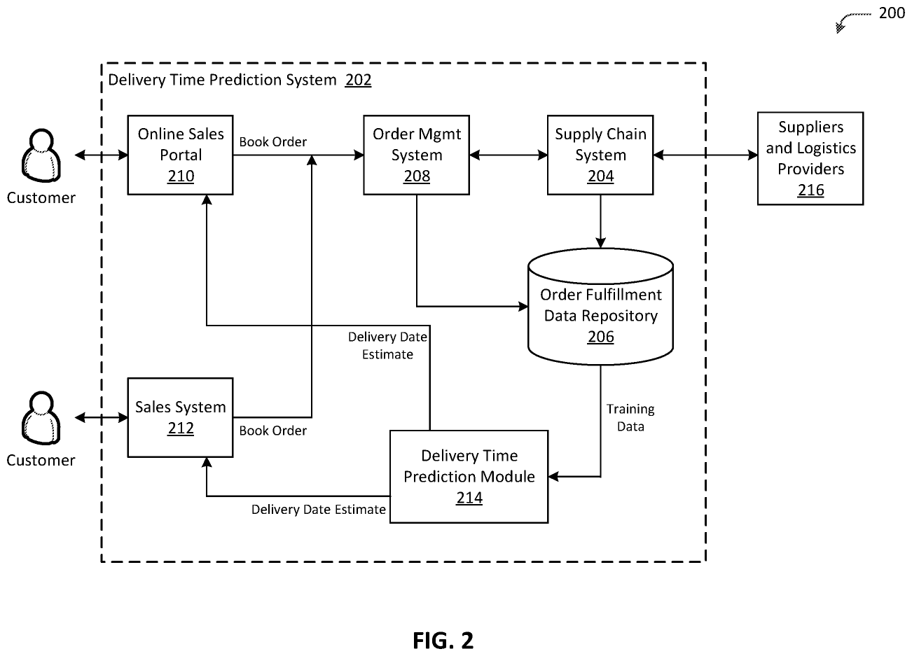

FIG. 2 is a diagram of an illustrative system architecture 200 including a delivery time prediction system 202, in accordance with an embodiment of the present disclosure. An enterprise, for instance, may implement and use delivery time prediction system 202 to determine expected delivery times for orders for one or more products being sold by the enterprise. As shown, delivery time prediction system 202 includes a supply chain system 204, an order fulfillment data repository 206, an order management system 208, an online sales portal 210, a sales system 212, and a delivery time prediction module 214. Delivery time prediction system 202 can include various other hardware and software components which, for the sake of clarity, are not shown in FIG. 2.

The various components of architecture 200, including the components of delivery time prediction system 202, may be communicably coupled to one another via one or more networks (not shown). The network may correspond to one or more wired or wireless computer networks including, but not limited to, local area networks (LANs), wide area networks (WANs), personal area networks (PANs), metropolitan area networks (MANs), storage area networks (SANs), virtual private networks (VPNs), wireless local-area networks (WLAN), primary public networks, primary private networks, Wi-Fi (i.e., 802.11) networks, other types of networks, or some combination of the above.

As shown in FIG. 2, architecture 200 also includes one or more suppliers and logistic providers 216 that provide parts used by the enterprise to create (e.g., manufacture) its products. For example, suppliers and logistic providers 216 may provide data, such as order fulfillment data, regarding the parts procured by the enterprise to supply chain system 204. The provided data may include information regarding the handing, transportation, and delivery (i.e., logistics) of the parts to the enterprise.

Supply chain system 204 provides management of the enterprise's supply chain activities, including planning, sourcing, producing, delivering, and providing for returns. Supply chain system 204 can store or otherwise maintain the data provided by suppliers and logistic providers 216 in a database or other persistent storage, such as, for example, order fulfillment data repository 206. Supply chain system 204 may also provide some or all of the data to order management system 208. Order management system 208 provides management of the enterprise's back-end process for managing and fulfilling orders. Order management system 208 can provide tracking of sales, orders, inventory, and fulfillment as well as facilitating automation between service providers (e.g., suppliers and logistics providers 216). Order management system 208 enables the enterprise to manage orders coming in (i.e., booked orders) from multiple sales channels and going out of multiple fulfillment points.

As can be seen in FIG. 2, one sales channel may be an online sales portal 210 for online sales of the enterprise's products. For example, a customer may access online sales portal 210 (e.g., an online interface of sales portal 210) and place or otherwise submit an order for the purchase of one or more products being sold by the enterprise. Prior to or at the time of placing the order, the customer may inquire as to an expected delivery time for the placed order. Online sales portal 210 can then book the placed order with order management system 208. In response, delivery time prediction module 214 can predict an expected delivery time for the individual products in the order, generate an estimate of an expected delivery time for the order based on the predicted expected delivery times, and send or otherwise provide the estimate of the expected delivery time for the order to online sales portal 210, as will be further described below. Online sales portal 210 can then display the estimated expected delivery time for viewing by the customer, for example. Note that the customer may inquire about an expected delivery time for an order without placing the order. For example, the customer may want to know when the customer can expect to receive delivery of a product or products before placing an order for the product(s).

Another example sales channel may be a sales system 212 for facilitating sales of the enterprise's products. In brief, sales system 212 may be a tool or collection of tools used by members of the enterprise's sales organization (e.g., salespersons) to manage sales opportunities. For example, a salesperson may use sales system 212 to record an order for one or more products that is being placed by a customer and inquire about an expected delivery time for the booked order. As another example, a salesperson may user sales system 212 to inquire as to an expected delivery time for an order being contemplated by a customer. In any case, sales system 212 can book the order with order management system 208 or send information regarding the inquiry as to the expected delivery time of an order to order management system 208. In response, delivery time prediction module 214 can predict an expected delivery time for the individual products in the order, generate an estimate of an expected delivery time for the order based on the predicted expected delivery times, and send or otherwise provide the estimate of the expected delivery time for the order to sales system 212, as will be further described below. The estimated expected delivery time can then be communicated to the customer.

Referring still to FIG. 2, order fulfillment data repository 206 stores or otherwise records the data provided by (or received via) supply chain system 204. This data may include order fulfillment information regarding the parts procured and/or used by the enterprise to create (e.g., manufacture) its products. Order fulfillment repository 206 also stores or otherwise records the data provided by (or received via) order management system 208. This data may include information regarding the booked orders for products as well as the order fulfillment information associated with the booked orders. Thus, in such embodiments, order fulfillment repository 206 can be understood as the storage point for the historical order fulfillment data that can be used to generate a training dataset with which to train a model (e.g., delivery time prediction module 214) to predict expected delivery times for products being sold by the enterprise.

In some embodiments, order fulfillment repository 206 may be configured to identify (e.g., extract) relevant features from the historical order fulfillment data and to generate a training dataset. In some such embodiments, order fulfillment repository 206 may identify the relevant features using the feature filtering and feature engineering techniques, as previously discussed herein with respect to feature filtering phase 104 and feature engineering phase 106 of FIG. 1. The generated training data set can then be used to train the model.

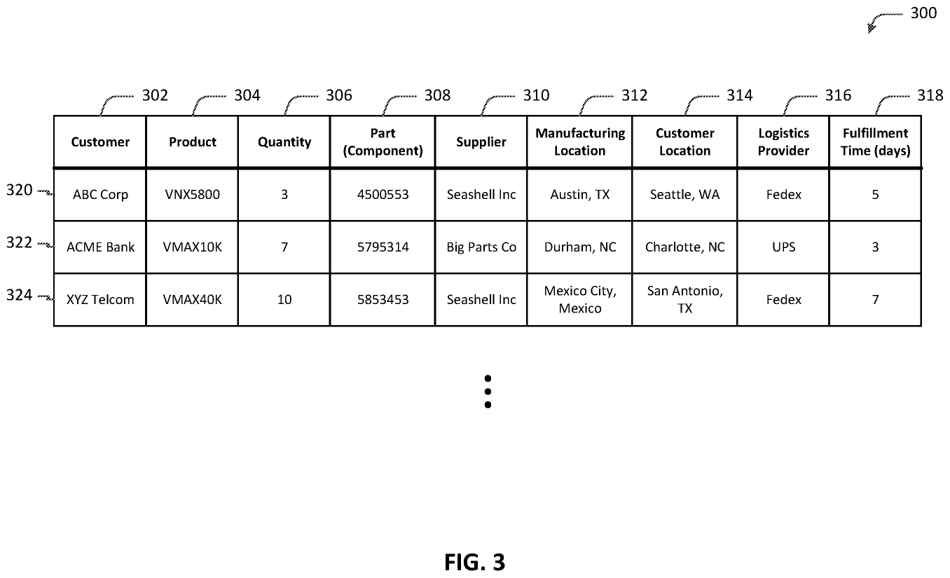

FIG. 3 is a diagram showing an illustrative data structure 300 that represents a training dataset, in accordance with an embodiment of the present disclosure. More specifically, the training dataset may be generated using the relevant features identified from the historical order fulfillment data. The relevant features may pertain to orders to for products, such as, consumer electronics products, build-to-order motor vehicles, custom heating and air conditioning systems, custom appliances, servers, storage systems, and any other product that is built (manufactured) to a specification after an order for the product is placed. The relevant features illustrated in data structure 300 are merely examples of features that may be extracted from the historical order fulfillment data and used to generate a training dataset and should not be construed to limit the embodiments described herein.

As shown in FIG. 3, the relevant features may include a customer 302, a product 304, a quantity 306, a part 308, a supplier 310, a manufacturing location 312, a customer location 314, a logistics provider 316, and a fulfillment time 318. Customer 302 indicates a customer that is purchasing the product (i.e., customer that placed the order for the product). Product 304 indicates a product number that identifies the product. Quantity 306 indicates the quantity of the product being purchased (i.e., quantity of the product being ordered). Part 308 indicates a part number that identifies a part (component) that is included in the product. For example, the indicated part is a part that is used in manufacturing the product. Supplier 310 indicates a supplier that is supplying the part. Manufacturing location 312 indicates a location at which the product is being manufactured. Customer location 314 indicates a location at which the customer is receiving the ordered product. Logistics provider 316 indicates a company or entity that is providing delivery of the product from the manufacturing location to the customer location. Fulfillment time 318 indicates the actual delivery time for the product. For example, the actual delivery time may be the period (e.g., number of days) from the booking of the order for the product to receipt of the ordered product by the customer. The features customer 302, product 304, quantity 306, part 308, supplier 310, manufacturing location 312, customer location 314, and logistics provider 316 may be included in a training sample as the independent variables, and the feature fulfillment time 318 included as the dependent (or target) variable in the training sample. Note that only one part (e.g., part 308) is shown as a relevant feature in FIG. 3 for purposes of clarity, and it will be appreciated that the relevant features can include more than one part as a product will typically include more than one part that has influence on the performance of the model (i.e., that are relevant (or influential) in predicting an expected delivery time).

In data structure 300, each row may represent a training sample (i.e., an instance of a training sample) in the training dataset, and each column may show a different feature of the training sample. As can be seen in FIG. 3, three training samples 320, 322, 324 are illustrated in data structure 300. In some embodiments, the individual training samples 320, 322, 324 may be used to generate a feature vector, which is a multi-dimensional vector of elements or components that represent the features in a training sample. In such embodiments, the generated feature vectors may be used for training a model to predict expected delivery times for products. Note that the number of training samples depicted in data structure 300 is for illustration, and those skilled in the at will appreciate that the training data set may, and likely will, include large and sometimes very large numbers of training samples.

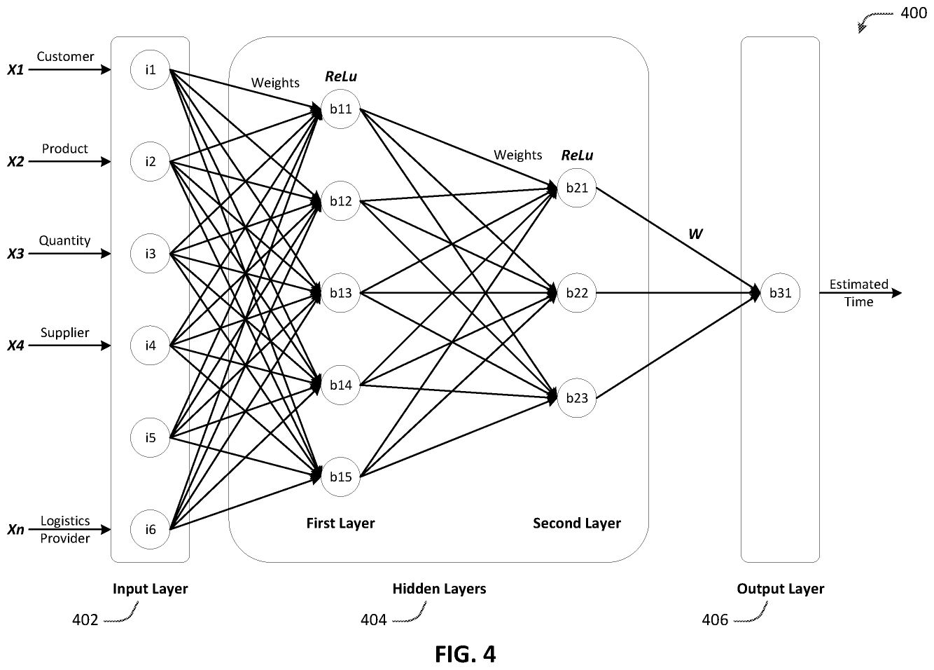

Referring again to FIG. 2, delivery time prediction module 214 can predict an expected delivery time for an ordered product when provided the details (information) regarding the ordered product. To this end, in some embodiments, delivery time prediction module 214 includes a trained learning model (e.g., a trained regression-based deep learning model) that is trained using machine learning techniques (including neural networks) with a training dataset generated using historical order fulfillment data regarding completed orders for one or more products, as variously described herein. In some embodiments, delivery time prediction module 214 may comprise a dense artificial neural network (ANN) model 400 as shown in FIG. 4. In brief, the ANN 400 includes an input layer 402, one or more hidden layers 404 (e.g., two hidden layers), and an output layer 406. Each layer may be comprised of a number of nodes or units embodying an artificial neuron (or more simply a “neuron”). As a regression-based model (or more simply a “regressor”), output layer 406 is comprised of a single neuron, which outputs a continuous, numerical value representing an expected delivery time of a product(s).

In more detail, and as shown in FIG. 4, input layer 402 may be comprised of a number of neurons to match (i.e., equal to) the number of input variables (independent variables). Taking as an example the independent variables illustrated in data structure 300 (FIG. 3), input layer 402 may include eight neurons to match the eight independent variables (e.g., features customer 302, product 304, quantity 306, part 308, supplier 310, manufacturing location 312, customer location 314, and logistics provider 316), where each neuron in input layer 402 receives a respective independent variable. Each successive layer (e.g., a first layer and a second layer) in hidden layers 404 will further comprise an arbitrary number of neurons, which may depend on the number of neurons included in input layer 402. For example, according to one embodiment, the number of neurons in the first hidden layer may be determined using the relation 2ⁿ≥number of neurons in input layer, where n is the smallest integer value satisfying the relation. In other words, the number of neurons in the first layer of hidden layers 404 is the smallest power of 2 value equal to or greater than the number of neurons in input layer 402. For example, in the case where there are 19 input variables, input layer 402 will include 19 neurons. In this example case, the first layer can include 32 neurons (i.e., 2⁵=32). Each successive layer in hidden layers 404 may be determined by decrementing the exponent n by a value of one. For example, the second layer can include 16 neurons (i.e., 2⁴=16). In the case where there is another successive layer (e.g., a third layer) in hidden layers 404, the third layer can include 8 neurons (i.e., 2³=8). As a regressor, output layer 406 includes a single neuron.

Although FIG. 4 shows hidden layers 404 comprised of only two layers, it will be understood that hidden layers 404 may be comprised of a different number of hidden layers. Also, the number of neurons shown in the first layer and in the second layer of hidden layers 404 is for illustration only, and it will be understood that actual numbers of neurons in the first layer and in the second layer of hidden layers 404 may be based on the number of neurons in input layer 402.

Each neuron in hidden layers 404 may be associated with an activation function. For example, according to one embodiment, the activation function may be a rectified linear activation function (ReLU). Since this is a dense network, as can be seen in FIG. 4, each neuron in the different layers may be coupled to one another. Each coupling (i.e., each interconnection) between two neurons may be associated with a weight, which may be learned during a learning or training phase. Each neuron may also be associated with a bias factor, which may also be learned during a training process.

During a first pass (epoch) in the training phase, the weight and bias values may be set randomly by the neural network. For example, according to one embodiment, the weight and bias values may all be set to 1 (or 0). Each neuron may then perform a linear calculation by combining the multiplication of each input variables (x1, x2, . . . ) with their weight factors and then adding the bias of the neuron. The formula for this calculation may be as follows:

ws1=x1·w1+x2·w2+ . . . +b1

where ws1 is the weighted sum of the neuron1, x1, x2, etc. are the input values to the model, w1, w2, etc. are the weight values applied to the connections to the neuron1, and b1 is the bias value of neuron1. This weighted sum is input to an activation function (e.g., ReLU) to compute the value of the activation function. Similarly, the weighted sum and activation function values of all the other neurons in a layer are calculated. These values are then fed to the neurons of the succeeding (next) layer. The same process is repeated in the succeeding layer neurons until the values are fed to the neuron of output layer 406. Here, the weighted sum may also be calculated and compared to the actual target value. Based on the difference, a loss value is calculated. The loss value indicates the extent to which the model is trained (i.e., how well the model is trained). This pass through the neural network is a forward propagation, which calculates the error and drives a backpropagation through the network to minimize the loss or error at each neuron of the network. Considering the error/loss is generated by all the neurons in the network, backpropagation goes through each layer from back to forward and attempts to minimize the loss using, for example, a gradient descent-based optimization mechanism or some other optimization method. Since the neural network is a regressor, mean squared error (MSE) may be used as the loss function and the adaptive movement estimation (Adam) as the optimization algorithm.

The result of this backpropagation is used to adjust (update) the weight and bias values at each connection and neuron level to reduce the error/loss. An epoch (one pass of the entire training dataset) is completed once all the observations of the training data are passed through the neural network. Another forward propagation (e.g., epoch 2) may then be initiated with the adjusted weight and bias values and the same process of forward and backpropagation may be repeated in the subsequent epochs. Note that a higher loss value means the model is not sufficiently trained. In this case, hyperparameter tuning may be performed. Hyperparameter tuning may include, for example, changing the loss function, changing optimizer algorithm, and/or changing the neural network architecture by adding more hidden layers. Additionally or alternatively, the number of epochs can be also increased to further train the model. In any case, once the loss is reduced to a very small number (ideally close to zero (0)), the neural network is sufficiently trained for prediction.

Once the model is sufficiently trained, delivery time prediction module 214 can be used to determine an expected delivery time for an order for one or more products. For example, according to one embodiment, to determine an expected delivery date for an order, delivery time prediction module 214 can identify the different (individual) products that are included in the order and, for each of the different products, predict an expected delivery date for that product. For example, for each of the different products in the order, the features from the order for the different product (or the order for multiple quantities of the different product) may be input, fed, or otherwise provided to the trained model to predict an expected delivery time of the different product (or multiple quantities of the different product) that is being ordered. For example, delivery time prediction module 214 can generate a feature vector that represents the features from the order, and the feature vector may be input to the trained model. The input features may include the same features used in training the trained model. Once the expected delivery dates for the different products in an order are predicted, delivery time prediction module 214 can determine an expected delivery time for the order based on the predicted expected delivery dates of the different products in the order.

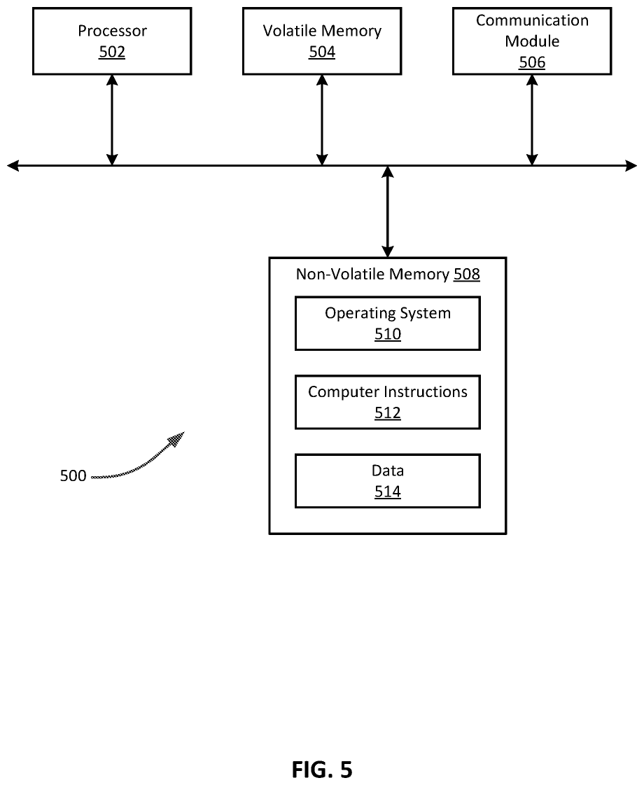

FIG. 5 schematically shows selective components of an illustrative computer system 500 that may be used in accordance with an embodiment of the concepts, structures, and techniques disclosed herein. As shown, computer system 500 includes a processor 502, a volatile memory 504, a communication module 506 (e.g., network chip or chipset which allows for communication via a network, a bus, an interconnect, etc.), and a non-volatile memory 508 (e.g., hard disk). Non-volatile memory 508 stores an operating system 510, computer instructions 512, and data 514. In one example, computer instructions 512 are executed by processor 502 out of volatile memory 504 to perform all or part of the processes described herein (e.g., processes illustrated and described in reference to FIGS. 1 through 4).

These processes are not limited to use with particular hardware and software; they may find applicability in any computing or processing environment and with any type of machine or set of machines that is capable of running a computer program. The processes described herein may be implemented in hardware, software, or a combination of the two. The processes described herein may be implemented in computer programs executed on programmable computers/machines that each includes a processor, a non-transitory machine-readable medium or other article of manufacture that is readable by the processor (including volatile and non-volatile memory and/or storage elements), at least one input device, and one or more output devices. In embodiments, the processor can include ASIC, FPGA, and/or other types of circuits. Program code may be applied to data entered using an input device to perform any of the processes described herein and to generate output information.

The system may be implemented, at least in part, via a computer program product, (e.g., in a non-transitory machine-readable storage medium such as, for example, a non-transitory computer-readable medium), for execution by, or to control the operation of, data processing apparatus (e.g., a programmable processor, a computer, or multiple computers)). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a non-transitory machine-readable medium that is readable by a general or special purpose programmable computer for configuring and operating the computer when the non-transitory machine-readable medium is read by the computer to perform the processes described herein. For example, the processes described herein may also be implemented as a non-transitory machine-readable storage medium, configured with a computer program, where upon execution, instructions in the computer program cause the computer to operate in accordance with the processes. A non-transitory machine-readable medium may include but is not limited to a hard drive, compact disc, flash memory, non-volatile memory, volatile memory, magnetic diskette and so forth but does not include a transitory signal per se.

The processes described herein are not limited to the specific examples described. For example, the processes of FIGS. 1 through 4 are not limited to the specific processing order illustrated. Rather, any of the processing blocks of the Figures may be re-ordered, combined or removed, performed in parallel or in serial, as necessary, to achieve the results set forth above.

The processing blocks associated with implementing the system may be performed by one or more programmable processors executing one or more computer programs to perform the functions of the system. All or part of the system may be implemented as, special purpose logic circuitry (e.g., an FPGA (field-programmable gate array) and/or an ASIC (application-specific integrated circuit)). All or part of the system may be implemented using electronic hardware circuitry that include electronic devices such as, for example, at least one of a processor, a memory, a programmable logic device, or a logic gate. It is understood that embodiments of event synchronization are applicable to a variety of systems, objects and applications.

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

What is claimed is:

1. A computer implemented method to generate a delivery time prediction module to predict an expected delivery time for a product, the method comprising:
receiving a corpus of historical order fulfillment data regarding a plurality of completed orders for one or more products, the historical order fulfillment data including an actual delivery time for each product in a completed order;
identifying, from the corpus of historical order fulfillment data, a plurality of features for a product, the plurality of features correlated with an actual delivery time for the product;
generating a training dataset using the identified plurality of features, the training dataset including a plurality of training samples, each training sample of the plurality of training samples corresponding to a product and including one or more identified features and the actual delivery time for the product; and
training the delivery time prediction module using the plurality of training samples.

2. The method of claim 1, wherein the plurality of features includes a feature regarding a customer location that indicates a location at which a customer received the product.

3. The method of claim 1, wherein the plurality of features includes a feature regarding a manufacturing location that indicates a location at which the product is manufactured.

4. The method of claim 1, wherein the plurality of features of includes a feature regarding a supplier location that indicates a location of a supplier of a component of the product.

5. The method of claim 4, wherein the plurality of features includes a feature regarding a logistics provider that indicates a company that provided delivery of the product.

6. The method of claim 1, wherein the plurality of features includes a feature that indicates a quantity of the product.

7. The method of claim 1, wherein the plurality of features includes a feature indicating a time period associated with the order of the product.

8. The method of claim 1, wherein the delivery time prediction module includes a regression-based model.

9. The method of claim 8, wherein the regression-based model includes an input layer that includes a number of neurons that match the plurality of features included in a training sample of the plurality of training samples.

10. The method of claim 8, wherein the regression-based model includes a plurality of hidden layers, each hidden layer of the plurality of hidden layers including a number of neurons based on a number of neurons included in an input layer of the regression-based model.

11. The method of claim 1, further comprising:
receiving an order for at least one product;
generating a feature vector for the at least one product; and
predicting, by the delivery time prediction module, an expected delivery time for the at least one product based on the generated feature vector.

12. A system comprising:
one or more non-transitory machine-readable mediums configured to store instructions; and
one or more processors configured to execute the instructions stored on the one or more non-transitory machine-readable mediums, wherein execution of the instructions causes the one or more processors to:
receive a corpus of historical order fulfillment data regarding a plurality of completed orders for one or more products, the historical order fulfillment data including an actual delivery time for each product in a completed order;
identify, from the corpus of historical order fulfillment data, a plurality of features for a product, the plurality of features correlated with an actual delivery time for the product;
generate a training dataset using the identified plurality of features, the training dataset including a plurality of training samples, each training sample of the plurality of training samples corresponding to a product and including one or more identified features and the actual delivery time for the product; and
train the delivery time prediction module using the plurality of training samples.

13. The system of claim 12, wherein the plurality of features includes a feature regarding one of a customer location that indicates a location at which a customer received the product, a manufacturing location that indicates a location at which the product is manufactured, or a supplier location that indicates a location of a supplier of a component of the product.

14. The system of claim 12, wherein the plurality of features includes a feature regarding a logistics provider that indicates a company that provided delivery of the product.

15. The system of claim 12, wherein the plurality of features includes a feature that indicates a quantity of the product.

16. The system of claim 12, wherein the plurality of features includes a feature indicating a time period associated with the order of the product.

17. The system of claim 12, wherein the delivery time prediction module includes a regression-based model.

18. The system of claim 17, wherein the regression-based model includes an input layer that includes a number of neurons that match the plurality of features included in a training sample of the plurality of training samples.

19. The system of claim 17, wherein the regression-based model includes a plurality of hidden layers, each hidden layer of the plurality of hidden layers including a number of neurons based on a number of neurons included in an input layer of the regression-based model.

20. A computer program product including one or more non-transitory machine-readable mediums encoding instructions that when executed by one or more processors cause a process to be carried out to generate a delivery time prediction module to predict an expected delivery time for a product, the process comprising:
receiving a corpus of historical order fulfillment data regarding a plurality of completed orders for one or more products, the historical order fulfillment data including an actual delivery time for each product in a completed order;
identifying, from the corpus of historical order fulfillment data, a plurality of features for a product, the plurality of features correlated with an actual delivery time for the product;
generating a training dataset using the identified plurality of features, the training dataset including a plurality of training samples, each training sample of the plurality of training samples corresponding to a product and including one or more identified features and the actual delivery time for the product; and
training the delivery time prediction module using the plurality of training samples.
